(19) United States
(12) Patent Application Publication
(10) Pub. No.: US 2012/0172490 A1
(43) Pub. Date: Jul. 5, 2012

(54) CARBON BLACK PIGMENTED INKJET INK TO REDUCE KOGATION AND IMPROVE TEXT QUALITY

(76) Inventors: Xiaorong Cai, Lexington, KY (US); Elaine Money, Lexington, KY (US)

(21) Appl. No.: 12/982,985

(22) Filed: Dec. 31, 2010

(51) Int. Cl. C09D 11/02; C08K 5/1515

(52) U.S. Cl. 523/122; 524/114

(57) ABSTRACT

The present invention relates to a carbon black inkjet ink having improved text quality and resistance to kogation. The formulation for inkjet ink combines a non-ionic ethoxylate surfactant having at least 30 moles of ethylene oxide with a particular set of three humectants. The inkjet ink formulation also included a polymeric dispersant.

### CROSS REFERENCE TO RELATED APPLICATIONS

This application is related to US publication 2010/0285219.

### MICROFICHE APPENDIX

None.

### GOVERNMENT RIGHTS IN PATENT

Not applicable.

### BACKGROUND OF THE INVENTION

1. Field of the Invention

The present invention relates to inkjet inks, and, more particularly, to a formulation for a carbon black ink for thermal inkjet printing which reduces kogation and provides good text quality.

2. Description of the Related Art

Ink jet printers are well known. One common type of ink jet printer uses a replaceable print cartridge having a printhead and a supply of ink contained within the cartridge. The printhead is installed in a printhead carrier, which positions the printhead along a printing zone. When the supply of ink contained within the print cartridge is depleted, the print cartridge is disposed of and a new print cartridge is installed in the printhead carrier. In contrast, off carrier inkjet printers deliver ink through supply tubes connected from a refillable off-carrier ink supply tank to an ink jet printhead positioned on the printhead carrier. This inkjet printhead is not disposable but permanent or semi-permanent in nature. Consequently, it is demanded by the consumer that these permanent or semi-permanent printheads have a longer life compared to a disposable printhead. When the supply of ink is exhausted, the consumer will purchase a new tank filled with ink as opposed to purchasing a brand new printhead containing the same supply of ink. This is a more economical option for the consumer. Therefore it is imperative that a permanent or semi-permanent printhead does not fail in their operations prematurely because it is expected that it will have a longer life.

Carbon black ink being jetted over the life of these printheads can cause many problems which affect the overall performance of the printheads. One of the most common problems is kogation. During the millions of firing of drops of carbon black ink from the printhead, the layer of ink covering the surface of the heating element of the printhead can reach a very high temperature, usually over 300° C. At this high temperature, ink decomposes, thereby depositing a residue onto the surface of the heater. This phenomenon is called kogation. The presence of this residue negatively affects the volume, weight, shape and velocity of each ejected drop of ink jetted from the printhead, thereby reducing the quality and the expected life of a thermal inkjet printhead. A loss of drop weight over the life of the printhead negatively reduces the accuracy of drop placement onto the print media. In extreme cases, kogation causes the printhead to stop working altogether. Therefore, it is necessary to have a carbon black ink that is not susceptible to this kogation phenomenon.

Additionally, there are many requirements demanded from consumers when purchasing carbon black ink including superior dark black text quality, crisp edge acuity and good ocular density. The ink must also have highlighter and smear resistance. The carbon black ink must have acceptable drying time and good adhesion when printed onto various types of media.

However, it is difficult to formulate a carbon black ink meeting all these requirements simultaneously. Consequently many trade-offs arise when trying to formulate a carbon black ink having most of these ink performance requirements demanded by the consumer. For example, increasing the carbon black pigment load in the formulation improves the darkness of the text but it also has a negative impact on jetting and heater kogation. Inventors have found that adding different surfactants into the carbon black ink formulation has different effects on these various ink performance requirements. For example, adding a particular type of surfactant into the ink formulation could speed up the penetration of ink on the media and improve the hi-liter and smear resistance but it also reduces the darkness of the text and increases the variation of the ocular density on different types of media. Other surfactants provide sharper test quality, but also negatively impact the jetting behaviors of the carbon black ink. Consequently, there is an obvious need to balance these competing factors when deciding exactly which surfactants to use to provide a carbon black ink which would prevent kogation while at the same time not sacrifice performance quality. The carbon black of the present invention balances these trade-offs to formulate an optimized ink formulation which reduces kogation while not sacrificing text quality.

Moreover, the type of humectants used also greatly affects these various ink requirements demanded in carbon black ink formulations. It is believed that the carbon black ink of the present invention uses a unique group of humectants in combination with a particular type of surfactant which surprisingly produces an optimal ink formulation that reduces kogation while simultaneously providing good text quality. With the increased usage of off carrier inkjet printing systems having permanent and semi-permanent printheads, reduction in kogation in the printhead is greatly needed.

### SUMMARY OF THE INVENTION

Exemplary embodiments of the present invention provide an inkjet ink comprised of a carbon black pigment dispersion being approximately 4% by weight of the inkjet ink; a non-ionic ethoxylate surfactant having a minimum of 30 moles of ethylene oxide (‘EO’) being about 0.1% to about 1.0% by weight of the inkjet ink; a polymeric dispersant being about 0.5% to about 1.5% by weight of the inkjet ink; and a humectant group consisting of 1,3-propanediol, glycerol and tri-ethylene glycol. This humectant group is approximately 20% by weight of the inkjet ink. The balance of the inkjet ink is water. Optionally, the inkjet ink may contain biocide. In the preferred embodiment, the nonionic surfactant contains 40 moles of EO and is approximately 0.2% by weight of the inkjet ink. This carbon black ink of the present invention controls kogation in addition to demonstrating good text quality. The carbon black ink of the present invention is especially useful in inkjet printing systems using semi-permanent or permanent printheads.

### BRIEF DESCRIPTION OF THE DRAWINGS

The above-mentioned and other features and advantages of this invention and the manner of attaining them, will become more apparent and the invention will be better understood by reference to the following description of embodiments of the invention taken in conjunction with the accompanying drawings, wherein:

FIG. 1 is a print pattern of a commercially available inkjet ink.

FIG. 2 is print pattern of an exemplary inkjet ink according to the present invention.

FIG. 3 is a photograph of a heater on a printhead using a commercially available carbon black inkjet ink.

FIG. 4 is a photograph of a heater on a printhead using the exemplary carbon black inkjet ink of the present invention.

The exemplification set out herein illustrates one embodiment of the invention and such exemplification is not to be construed as limiting the scope of the invention in any manner.

### DETAILED DESCRIPTION OF THE INVENTION

It has been found that a particular group of 3 humectants used in combination with a particular type of surfactant produces a carbon black inkjet ink which controls and or reduces kogation in addition to providing good text quality.

In various exemplary embodiments of the present invention, the inkjet ink is comprised of a carbon black pigment dispersion, a non-ionic ethoxylate surfactant, a polymeric dispersant, and three particular humectants. It is preferred that the non-ionic ethoxylate surfactant be of about 0.1% to about 1.0% by weight of the inkjet ink. In a more preferred embodiment, the non-ionic ethoxylate surfactant is about 0.2% to about 0.8% by weight of the inkjet ink. In the most preferred embodiment, the non-ionic ethoxylate surfactant is about 0.2% by weight of the inkjet ink. The non-ionic ethoxylate surfactant assists in wetting, surface activation and bubble control of the inkjet ink.

In exemplary embodiments, the non-ionic ethoxylate surfactant has a molecular weight between 1955 and 1970 and is in the form of an alkyl phenol having between 30 moles and 70 moles of EO. Secondary alcohol ethoxylate surfactants can also be used. Most preferred is the octylphenol type of alkyl phenol ethoxylate surfactants. Non-ionic ethoxylate surfactants having high hydrophile-lipophile balance ('HLB') number between 17 and 19 are preferred. The surface tension should be controlled in the range between 35 and 50 dyne/cm. In the most preferred embodiment, the non-ionic surfactant is an octyphenol ethoxylate having 40 moles of EO, a HLB number of 17.9 and a surface tension of 37 dyne/cm. Without being bond by theory, it is believed that a high number of moles of EO in the surfactant results in improving kogation and reduction of pigment buildup on the heater on the printhead. A surfactant having a higher HLB number and surface tension slows down the ink spreading speed on the paper and results in sharper text. The higher HLB number and surface tension also slows down the ink penetration speed on the paper, especially on plain paper. This results in a higher ocular density or more pigment cake on the surface of the plain paper. Therefore, media sensitivity is also reduced.

A commercially available non-ionic octylphenol ethoxylate surfactant having these specifications is Triton® X-405 commercially available from Dow Chemical Company or Iconol® OP-40 commercially available from BASF Corporation. Both of these surfactants have 40 moles of EO. Triton® X-405 has a HLB number of 17.9, a surface tension of 37 dyne/cm and a molecular weight of 1967. Another useful surfactant is a secondary alcohol ethoxylate surfactant containing 40 moles of EO sold by Dow Chemical Company under the trade name Tergitol® 15-S-40 having a HLB number of 18, a surface tension of 45 dyne/cm and a molecular weight of 1960. Other surfactants useful in the current carbon black ink formulation are Triton® X-305 (30 moles EO) and X-705 (70 moles EO) available from Dow Chemical Company and Iconol® OP-30 (30 moles EO) available from BASF Corporation. In the preferred embodiment, the surfactant should be between approximately 0.2% by weight to approximately 0.8% by weight of the inkjet ink. In the most preferred embodiment, the surfactant should be approximately 0.2% by weight of the total weight of the inkjet ink.

In the exemplary embodiments, a unique set of humectants is used in combination with the above described surfactant to produce a carbon black ink which reduces kogation in addition to providing good text quality. The set of humectants consists of 1,3 propanediol, glycerol, and tri-ethylene glycol and is about 20% by weight of the inkjet ink. In the preferred embodiment, the glycerol is 10.0% by weight of the inkjet ink, the triethylene glycol is 5.0% by weight of the inkjet ink and the 1,3 propanediol is 5.0% by weight of the inkjet ink.

The polymeric dispersant used in the carbon black inkjet ink of the present invention is preferably about 0.5% to about 1.5% by weight of the inkjet ink and assists in stabilizing the carbon black pigment and buffering the pH of the inkjet ink. In various exemplary embodiments, the polymeric dispersant is a ter-polymer or acrylic polymer having moieties of acrylic acid or lower alkyl substituted acrylic acid (MAA), poly(propylene glycol)-4-nonylphenyl ether acrylate (NPHPPG), and poly(ethylene glycol)2,4,6-tris-(1-phenylethyl)phenyl ether methacrylate (TRISA). In exemplary embodiments, a molar ratio of MAA in the polymeric dispersant is about 15 parts to about 2 parts of a combination of NPHPPG and TRISA, and a molar ratio of TRISA in the polymeric dispersant is about 1 part to about 16 parts of a combination of NPHPPG and MAA. Due to the insolubility of the carbon black pigment in water, the polymeric dispersant is typically added to the ink formulation to improve the dispersibility of the pigment.

The dispersants used in the invention include Lexmark® acrylic polymer dispersant having moieties consisting essentially of acrylic acid or lower alkyl substituted acrylic acid (MAA), poly(propylene glycol)-4-nonylphenyl ether acrylate (NPHPPG), and poly(ethylene glycol)2,4,6-tris-(1-phenylethyl)phenyl ether methacrylate (TRISA). This dispersant is more particularly described in U.S. Pat. No. 6,652,634 assigned to the assignee of the present invention. Another acceptable dispersant is an acrylic polymer dispersant available from BASF Company under the trade name Joncryl® HPD-671. In an embodiment, the amount of dispersant used in the carbon black ink of the present invention is between 0.5% by weight to 1.5% by weight, preferably 1.0% by weight of the carbon black inkjet ink.

The ink formulations in this invention contains carbon black pigment dispersion a unique set of three humectants, a non-ionic ethoxylate surfactant, a polymer dispersant, a biocide, and the balance water. The carbon black ink dispersion is available from Sun Chemical Company under the trade name Kau pigment concentration. The carbon black pigment dispersion should be between 3% by weight to 5% by weight of the total weight if the inkjet ink. Most preferably, the pigment dispersion should be 4% by weight of the total weight of the inkjet ink. The biocide should be between approximately 0.10% by weight to approximately 0.22% by weight of the total weight if the inkjet ink. Most preferably, the biocide should be approximately 0.21% by weight of the total weight of the inkjet ink. The inks were manufactured according to the following general procedure: Weigh the balance of the water in a beaker then place the beaker on top of a magnetic mixer. Weigh and add each ingredient in the following order while keeping the mixer on—humectants, dispersants, surfactant, biocide and carbon black pigment. Wait at least 5 minutes before adding each ingredient. Keep the mixer on for another 10 minutes after the addition of all the ingredients is complete. Filter the ink using 5 microns and 1.2 micron filters. Seven different carbon black inks were formulated following this method and each of their respective ingredients and amounts are listed in Table 1 below:

TABLE 1

| | CARBON | | | | | | | |
|---|---|---|---|---|---|---|---|---|
| | BLACK | | TRIETHYLENE | 1,3- | POLYMER | | | |
| INK | DISPERSION | GLYCEROL | GLYCOL | PROPANEDIOL | DISPERSANT | SURFACTANT | BIOCIDE | DI WATER |
| Control | 3.5% | 10% | 5% | 5% | 1% | Silwet L7600, | Kordek MLX, | Balance |
| | | | | | | 0.5% | 0.15% | |
| Example | 4.0% | 10% | 5% | 5% | 1% | Triton X-305, | Proxel GXL, | Balance |
| Ink 1 | | | | | | 0.2% | 0.15% | |
| Example | 4.0% | 10% | 5% | 5% | 1% | Triton X-405, | Proxel GXL, | Balance |
| Ink 2 | | | | | | 0.2% | 0.063% + | |
| | | | | | | | Kordek MLK, | |
| | | | | | | | 0.15% | |
| Example | 4.0% | 10% | 5% | 5% | 1% | Triton X-705, | Proxel GXL, | Balance |
| Ink 3 | | | | | | 0.2% | 0.15% | |
| Example | 4.0% | 10% | 5% | 5% | 1% | Triton X-405, | Proxel GXL, | Balance |
| Ink 4 | | | | | | 0.8% | 0.15% | |
| Example | 4.0% | 10% | 5% | 5% | 1% | Iconol OP-40, | Proxel GXL, | Balance |
| Ink 5 | | | | | | 0.8% | 0.15% | |
| Example | 4.0% | 10% | 5% | 5% | 1% | Tergitol 15-S-40, | Proxel GXL, | Balance |
| Ink 6 | | | | | | 0.2% | 0.15% | |

The above seven ink formulations listed in Table 1 were tested in a Lexmark® Intuition® S505 printer. The printing quality was evaluated based on idle time in the environment controlled room at 60° F. and 8% humidity. The text score is performed under an ambient environment. Idle time is defined as how many seconds the printhead has been in idle and still can be jetted without missing or misdirected dots. The higher the time the better the text score. The text score is a text metrics consisting of 6 elements: image blur, edge raggedness, contrast, line contrast, horizontal resolution and vertical resolution. The lower the text scores, the better the text quality. In current examples, the text scores are the average of text scores from three papers including Hammermill® Laser Print, Printwork® Multi-purpose, and, Hammermill® Tidal Multi-Purpose. The media sensitivity was calculated using the standard deviation of the OD/L* measured from the following 6 papers: Hammermill® Laser Print, Printwork® Multi-purpose, Xerox® 4200, Hammermill® Tidal Multi-Purpose, Hewlitt-Packard® Multi-Purpose and Hammermill® Copy Plus These test results of the inks listed in Table 1 are shown in Table 2:

TABLE 2

| | | SURFACE | IDLE | | | MEDIA |
|---|---|---|---|---|---|---|
| | | TENSION | TIME | TEXT | | SENSITIVITY |
| INK ID | SURFACTANT | (dyne/cm) | (sec) | SCORE | OD | (stdev) |
| Control | Silwet L7600 | 33.5 | 2.2 | 2.2 | 1.40 | 0.08 |
| Example 1 | 0.2% Triton X-305 | 44.0 | 2.0 | 1.9 | 1.45 | 0.04 |
| Example 2 | 0.2% Triton X-405 | 44.2 | 2.1 | 1.9 | 1.45 | 0.04 |
| Example 3 | 0.2% Triton X-705 | 44.2 | 2.0 | 2.0 | 1.44 | 0.05 |
| Example 4 | 0.8% Triton X-405 | 44.0 | 2.2 | 2.0 | 1.44 | 0.05 |
| Example 5 | 0.8% Iconol OP-40 | 44.0 | 1.9 | 2.0 | 1.44 | 0.04 |
| Example 6 | 0.2% Tergitol 15-S-40 | 44.3 | 1.9 | 1.9 | 1.44 | 0.04 |

As illustrated with the above results in Table 2, the example inkjet inks, numbers 1-6 formulated according to the present invention show an improvement in text quality, ocular density and media sensitivity over the commercially available control inkjet ink.

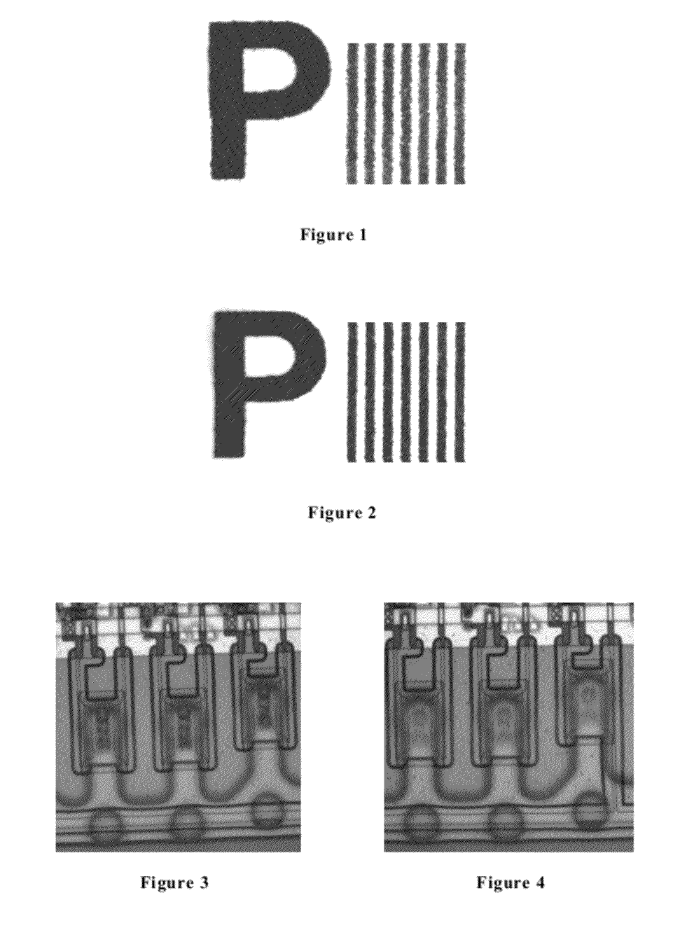

FIG. 1 illustrates the printed pattern of the commercially available inkjet formulation listed as the control ink in Table 1. FIG. 2 illustrates a printed pattern of the ink formulation listed as ink number 2 in Table 1. It can be seen from a comparison of FIGS. 1 and 2 that the print pattern in FIG. 2 has much crisper and more defined edges than the print pattern in FIG. 1.

FIG. 3 is a picture of a heater on a printhead taken after the printing of 2500 pages using the control ink from Table 1. FIG. 4 is also a picture of a heater on a printhead taken after the printing of 2500 pages using ink number 4 from Table 1. It can be seen from a review of these pictures that the heater pictured in FIG. 3 shows kogation while the heater in FIG. 4 does not show any signs of kogation.

The reduction of ink drop mass and ink drop velocity directly reflects the pigment build-up on the heater or kogation. More build-up of material on the heater will result in a reduction of ink drop size or mass and a reduction in drop speed or velocity. The ink drop mass and ink drop velocity on a Lexmark® Intuition® S505 printer were measured initially and after printing 12 tanks of inks, approximately 150 ml. The percentage of drop mass and drop velocity changes are shown in Table 3 below. Example 4 ink from Table 1 showed lower reductions in both ink drop mass and ink drop velocity than the control ink listed in Table 1.

TABLE 3

| | INITIAL | INITIAL | FINAL DROP | FINAL DROP | % OF DROP | % OF DROP |
|---|---|---|---|---|---|---|
| | DROP | DROP | MASS AFTER | VELOCITY AFTER | MASS | VELOCITY |
| INK | MASS | VELOCITY | 12 TANKS | 12 TANKS | REDUCTION | REDUCTION |
| Control | 5.2 | 535 | 4.8 | 458 | 7.6% | 14% |
| Example | 5.6 | 558 | 5.6 | 556 | 0% | 0.4% |
| Ink 4 | | | | | | |

As exemplified in the above results, the carbon black inkjet inks formulated according to the present invention exhibit a reduction of kogation in the printhead and have good text quality when compared to the commercially available carbon black inkjet ink.

While this invention has been described with respect to at least one embodiment, the present invention can be further modified within the spirit and scope of this disclosure. This application is therefore intended to cover any variations, uses or adaptations of the invention using its general principles. Further, this application is intended to cover such departures from the present disclosure as come within known or customary practice in the art to which this invention pertains and which fall within the limits of the appended claims.

What is claimed:

1. An inkjet ink comprising:
a carbon black pigment dispersion being about 4% by weight of the inkjet ink;
a non-ionic ethoxylate surfactant having at least 30 moles of ethylene oxide, said surfactant being about 0.1% to about 0.8% by weight of the inkjet ink;
a polymeric dispersant being about 0.5% to about 1.5% by weight of the inkjet ink; and
a humectant group consisting of 1,3-propanediol, glycerol and tri-ethylene glycol, said humectant group being approximately 20% by weight on the inkjet ink, whereby said inkjet ink reduces kogation and has good text quality.

2. The inkjet ink according to claim 1, wherein the non-ionic ethoxylate surfactant is an ethoxylated alkyl phenol having between 30 moles and 70 moles of ethylene oxide.

3. The inkjet ink according to claim 2, wherein the non-ionic octyphenol ethoxylate surfactant has 40 moles of ethylene oxide.

4. The inkjet ink according to claim 1, wherein the non-ionic ehtoxylate surfactant has a molecular weight between 1950 and 1970.

5. The inkjet ink of claim 4, wherein the non-ionic ethoxylate surfactant has a molecular weight of 1967.

6. The inkjet ink according to claim 1, wherein the non-ionic ethoxylate surfactant has a hydrophile-lipophile balance number between 17 and 19.

7. The inkjet ink according to claim 6, wherein the non-ionic ethoxylate surfactant has a hydrophile-lipophile balance number of 17.9.

8. The inkjet ink according to claim 1, wherein the non-ionic ethoxylate surfactant is secondary alcohol ethoxylate having 40 moles of ethoxylated oxide.

9. The inkjet ink according to claim 1, wherein the polymeric dispersant is a ter-polymer of acrylic polymer having moieties of acrylic acid or lower alkyl substituted acrylic acid (MAA); poly (propylene glycol)-4-nonylphenyl ether acrylate (NPHPPG); and poly (ethylene glycol)2,4,6-tris-(1-phenylethyl)phenyl ether methacrylate (TRISA).

10. The inkjet ink according to claim 9, wherein a molar ration of MAA in the polymeric dispersant is about 15 parts to about 2 parts of a combination of NPPHPPG and TRISA, and a molar ratio of TRISA in the polymeric dispersant is about 1 part to about 16 parts of a combination of NPHPPG and MAA.

11. The inkjet ink of claim 1, wherein the humectant group is 5% by weight of 1,3-propanediol, 10% by weight of glycerol and 5% by weight of tri-ethylene glycol of the total weight of the inkjet ink.

12. The inkjet ink according to claim 1, further comprising of biocide and water.
